(19) United States
(12) Patent Application Publication
(10) Pub. No.: US 2018/0011809 A9
(43) Pub. Date: Jan. 11, 2018

(54) MOBILE DEVICE AND METHOD FOR READING UART DATA

(71) Applicants: LE HOLDINGS (BEIJING) CO., LTD., Beijing (CN); LEMOBILE INFORMATION TECHNOLOGY (BEIJING) CO., LTD., Beijing (CN)

(72) Inventors: Zhiyue CHEN, Beijing (CN); Rong ZHOU, Beijing (CN)

(21) Appl. No.: 15/242,061

(22) Filed: Aug. 19, 2016

Related U.S. Application Data
(63) Continuation of application No. PCT/CN2016/088699, filed on Jul. 5, 2016.

(30) Foreign Application Priority Data
Mar. 25, 2016 (CN) 2016101770436

(51) Int. Cl. G06F 13/38; G06F 13/42; G06F 13/40

(52) U.S. Cl. CPC G06F 13/385; G06F 13/4022; G06F 13/4282

(57) ABSTRACT

Disclosed is a mobile device which comprises a CPU, a USB Type-C interface and a switching circuit. The switching circuit is configured to switch a connection line of two preset pins of the USB Type-C interface to connect UART TxD and UART RxD pins of the CPU, upon detecting that a UART cable is inserted into the USB Type-C interface.

### CROSS REFERENCE TO RELATED APPLICATIONS

This application is the continuation of the International application No. PCT/CN2016/088699PCT filed on Jul. 5, 2016, which is based upon and claims priority to Chinese Patent Application No. 201610177043.6, titled “A MOBILE DEVICE”, filed on Mar. 25, 2016, the entire contents of which are incorporated herein by reference.

### TECHNICAL FIELD

The embodiment of the present invention relates to a mobile device and a method for reading UART data, and in particular to a mobile device which can read UART data through a USB Type-C interface and a method for reading UART data.

### BACKGROUND

Operating state information of a mobile device, which can be used to debug the respective functions of a mobile device, is recorded in log data of Universal Asynchronous Receiver Transmitter (UART). Thus, software and hardware engineers need to read and analyze UART Log data while analyzing and solving a bug occurring in usage of the mobile device.

On the other hand, with regard to a current mobile device, in order to get portability, an interface disposed at the outside of its whole body portion is substantially configured with only a universal serial bus (USB) interface through which charging and data transmission are performed. However, the UART Log data cannot be read through the USB interface.

Currently, when the bug occurs in the whole body portion of the mobile device and the software and hardware engineers are required to analyze the bug, only dismounting may be performed, and then UART data read cables are soldered, so as to read the UART Log data. Specifically, the UART data read cables may be connected to UART TxD pins and UART RxD pins for receiving and outputting UART information, of a processor (CPU) of the mobile device. However, during dismounting, damage may be caused to elements and components of the mobile device such as LCD/touch buttons.

### SUMMARY

Therefore, an object of the present invention is to provide a solution in which the UART Log data can be read without necessarily dismounting the mobile device, against the aforesaid deficiencies in the prior art.

In accordance with embodiments of the present invention, there is provided a mobile device which comprises a CPU, a USB Type-C interface and a switching circuit. The switching circuit is configured to switch a connection line of two preset pins of the USB Type-C interface to connect UART TxD pins and UART RxD pins of the CPU, upon detecting that a UART cable is inserted into the USB Type interface.

In one embodiment, the switching circuit is configured to determine the type of the cable inserted into the USB Type-C interface by detecting the resistance values of CC1 and/or CC2 pins of the USB Type-C interface.

In one embodiment, the two preset pins of the USB Type-C interface are a SBU1 pin and a SBU2 pins of the USB Type-C interface.

In one embodiment, the mobile device is a smart phone.

In accordance with the embodiments of the present invention, the UART Log data can be read through the USB Type-C interface, without necessarily dismounting the mobile device at the time of reading the UART data.

In accordance with the embodiments of the present invention, it is also provided a method for reading UART data applied to a mobile terminal, comprising: detecting the type of a cable inserted into the USB Type-C interface; switching a connection line of the preset pins of the USB Type-C interface to connect UART related interfaces of the mobile device, upon detecting that a UART cable is inserted into the USB Type-C interface.

### BRIEF DESCRIPTION OF THE DRAWINGS

One or more embodiments are illustrated by way of example, and not by limitation, in the figures of the accompanying drawings, wherein elements having the same reference signs represent like elements throughout. The drawings are not to scale, unless otherwise disclosed. In the drawings:

FIG. 1 illustrates a schematic diagram of assignment of socket pins according to USB Type-C specification.

FIG. 2 illustrates a schematic diagram of a principle of a mobile device in accordance with one embodiment of the present invention;

FIG. 3 illustrates a flow chart of a method for reading UART data in accordance with one embodiment of the present invention.

### DETAILED DESCRIPTION

Hereinafter, the exemplary embodiments of the disclosure will be described with reference to the accompanying drawings. Although the exemplary embodiments of the disclosure are shown in the drawings it should be understood that the disclosure may be implemented in various forms and should not be limited by the embodiments set forth herein. On the contrary, these embodiments are provided for the purposes of more thoroughly understanding the disclosure, and the scope of the disclosure can be entirely conveyed to those skilled in the art.

New specification USB 3.1 of Universal Serial Bus (USB) was proposed in 2013, and the newly-added Type-C specification in USB was published in August, 2014. The USB Type-C interface appeared after the generation of USB 3.1. Its highlight is to support two-side insertion of a USB interface, thinner design, higher transmission speed (maximum 10 Gbps) and stronger power transmission (maximum 100 W). By means of these strong advantages, the USB Type-C interface gains favour and powerful promotion of mobile device manufactures such as APPLE, NOKIA and so on, and the mobile device equipped only with the USB Type-C interface is becoming a kind of trend increasingly.

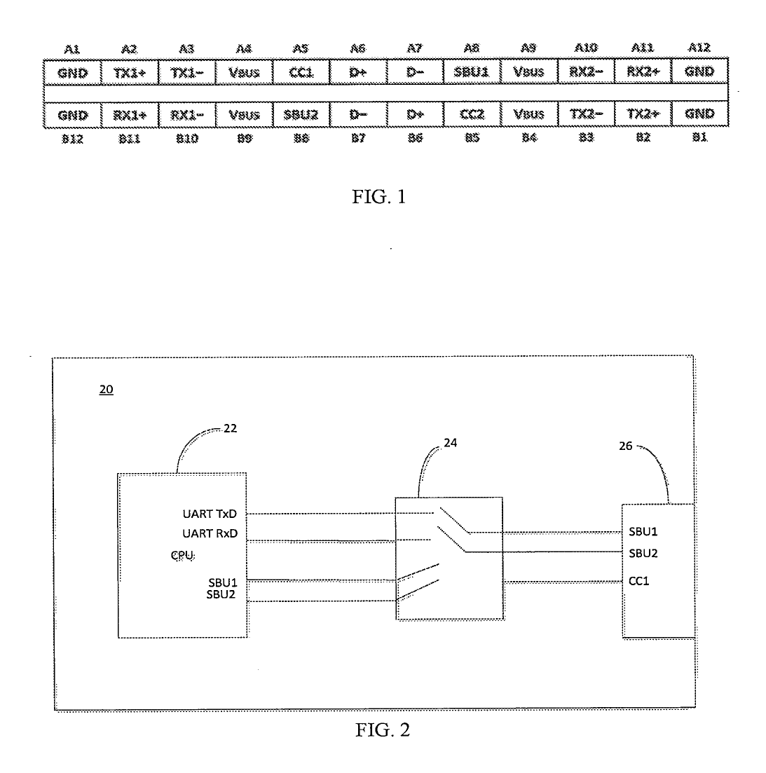

USB Developer Forum (USB-IF) issued Universal Serial Bus (USB) Type-C Cable and Connector Specification (version 1.0) on Aug. 11, 2014, which defines 24 pins of Type-C socket interface and their assignment. FIG. 1 illustrates a schematic diagram of assignment of socket pins according to the USB Type-C specification in a form of a main view. Table 1 allows signs, names and descriptions of the 24 pins.

TABLE 1

| Identity | Name | Description |
|---|---|---|
| A1 | GND | Grounded |
| A2 | TX1+ | A pair of |
| A3 | TX1− | differential |
| | | signals |
| A4 | V_{BUS} | Power |
| A5 | CC1 | Configuration |
| | | channel signal |
| A6 | D+ | A pair of |
| A7 | D− | differential |
| | | signals |
| A8 | SBU1 | Sideband usage |
| A9 | V_{BUS} | Power |
| A10 | RX2− | A pair of |
| A11 | RX2+ | differential |
| | | signals |
| A12 | GND | Grounded |
| B1 | GND | Grounded |
| B2 | TX2+ | A pair of |
| B3 | TX2− | differential |
| | | signals |
| B4 | V_{BUS} | Power |
| B5 | CC2 | Configuration |
| | | channel signal |
| B6 | D+ | A pair of |
| B7 | D− | differential |
| | | signals |
| B8 | SBU2 | Sideband usage |
| B9 | V_{BUS} | Power |
| B10 | RX1− | A pair of |
| B11 | RX1+ | differential |
| | | signals |
| B12 | GND | Grounded |

In accordance with the USB Type-C specification, CC1 and CC2 pins are two critical pins and have a lot of functions such as detecting connection, differentiating between front side and rear side, configuring VBUS pins, configuring other modes (for example, connecting audio parts, PCIE) and the like. Two pairs of TX/RX differential signals are used for data transmission of USB 3.1 standard, and a pair of D+/D− differential signals are used for data transmission compatible with USB 2.0 standard. SBU1 and SBU1 pins are the reserved pins conforming to Type-C specification and are used fur function extension. The USB Type-C interface also includes 4 grounded pins and 4 power pins.

FIG. 2 illustrates a schematic diagram of a of a mobile device 20 in accordance with one embodiment of the present invention. The mobile device 20 comprises a CPU 22, a USB Type-C interface 26 and a switching circuit 24. The switching circuit is configured to switch a connection line of two preset pins of the USB Type-C interface to UART TxD and UART RxD pins of the CPU, upon detecting that a cable for reading UART Log data is inserted into the USB Type-C interface. Thus, the UART Log data can be read by inserting a UART data read cable into the USB Type-C interface 26.

As an example, SBU1 and SBU2 pins preserved and unused in the USB Type-C specification may be used as the preset pins. When a normal USB Type-C cable is inserted, the switching circuit 24 switches to the state where SBU1/SBU2 pins of the Type-C interface 26 are respectively connected to SBU1/SBU2 of CPU 22 side. When a Type-C cable for reading the UART Log data is inserted, the switching circuit 24 switches to the state where the SBU1/SBU2 of the Type-C interface 26 are respectively connected to UART TxD/UART RxD of CPU 22 side, thereby a UART connection is established and the UART Log data is read.

It should be understood that it is just exemplary and not limiting to use both SBU 1 and SBU2 pins for reading the UART Log data. In the case that the current mobile device can only support USB 2.0 data transmission and charge, although the mobile device is equipped with the USB full-function Type-C interface, the pins of two pairs of TX/RX differential signals therein are unused. Thus, two pins of the eight pins can also be used for reading the UART Log data. In the case that most of the devices which interact with the USB full-function equipped Type-C interface support USB3.0 in the future, two pins among the D+/D− pins for data transmission compatible with USB2.0 standard may be also used.

In accordance with the embodiment of the present invention, the type of the cable inserted into the USB Type-C interface may be determined by judging the usage state of other pins than the aforementioned preset pins in the USB Type-C interface. For example, when the type of the inserted cable is a UART cable, many pins other than the aforementioned preset pins in the USB Type-C interface are in the high resistance value state of “suspended”. As an example, the type of the cable inserted into the USB Type-C interface may be determined by detecting the resistance values of CC1 and/or CC2 pins of the USB Type-C interface, that is it is determined whether the type of the cable is a USB Type-C cable or a UART cable.

The examples of the mobile device as described in the embodiments of the invention include but are not limited to a cellular phone, a smart phone, a media player or a portable computer similar to a tablet computer, and any other mobile devices which record the UART Log data.

In accordance with the embodiments of the present invention, the switching circuit is added into the mobile device, and thus, the UART data can be read through the USB Type-C interface without dismounting.

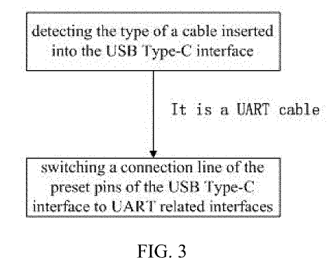

FIG. 3 illustrates a method for reading UART data in accordance with one embodiment of the present invention. The method is applied to a mobile terminal, comprising the following steps: detecting the type of a cable inserted into the USB Type-C interface; switching a connection line of the preset pins of the USB Type-C interface to connect UART related interfaces of the mobile device, upon detecting that a UART cable is inserted into the USB Type-C interface.

Wherein detection of the type of the cable inserted into the USB Type-C interface can comprise determining the type of the cable inserted into the USB Type-C interface by detecting resistance values of CC1 and/or CC2 pins of the USB Type-C interface.

Wherein the preset pins of the USB Type-C interface can be SBU1 and SBU2 pins of the USB Type-C interface.

Wherein the UART related interfaces are UART TxD pins and UART RxD pins.

Wherein the UART TxD pins and UART RxD pins are fixed pins of a processor of the mobile device.

Wherein the mobile device can be a smart phone.

The foregoing description of the present invention has been provided for the purposes of illustration and description, it is not intended to be exhaustive or to limit the invention to the forms disclosed. Obviously, many modifications and variations will occur to those skilled in the art. Without departing from the spirit of the invention, all of the modifications and alternate will fall into the protection scope of the invention defined by the attached claims.

1-6. (canceled)

7. A mobile device comprising:
a USB Type-C interface; and
a switching circuit configured to switch a connection line of the preset pins of the USB Type-C interface to connect UART related interfaces of the mobile device, upon detecting that a UART cable is inserted into the USB Type-C interface.

8. The mobile device according to claim 7, wherein the switching circuit is configured to determine the type of the cable inserted into the USB Type-C interface by detecting resistance values of CC1 and/or CC2 pins of the USB Type-C interface.

9. The mobile device according to claim 7, wherein the preset pins of the USB Type-C interface are a SBU1 pin and a SBU2 pin of the USB Type-C interface.

10. The mobile device according to claim 8, wherein the preset pins of the USB Type-C interface are a SBU1 pin and a SBU2 pin of the USB Type-C interface.

11. The mobile device according to claim 9, wherein the UART related interfaces are UART TxD pins and UART RxD pins.

12. The mobile device according to claim 11, wherein the UART TxD pins and UART RxD pins are fixed pins of a processor of the mobile device.

13. The mobile device according to claim 7, wherein the mobile device is a smart phone.

14. A method for reading UART data applied to a mobile terminal, comprising:
detecting the type of a cable inserted into the USB Type-C interface;
switching a connection line of the preset pins of the USB Type-C interface to connect UART related interfaces of the mobile device, upon detecting that a UART cable is inserted into the USB Type-C interface.

15. The method according to claim 14, wherein the detection of the type of the cable inserted into the USB Type-C interface can comprise: determining the type of the cable inserted into the USB Type-C interface by detecting resistance values of CC1 and/or CC2 pins of the USB Type-C interface.

16. The method according to claim 14, wherein the preset pins of the USB Type-C interface are a SBU1 pin and a SBU2 pin of the USB Type-C interface.

17. The method according to claim 15, wherein the preset pins of the USB Type-C interface are a SBU1 pin and a SBU2 pin of the USB Type-C interface.

18. The method according to claim 16, wherein the UART related interfaces are UART TxD pins and UART RxD pins.

19. The method according to claim 18, wherein the UART TxD pins and UART RxD pins are fixed pins of a processor of the mobile device.

20. The method according to claim 14, wherein the mobile device is a smart phone.
